(19) United States
(12) Patent Application Publication
(10) Pub. No.: US 2012/0218072 A1
(43) Pub. Date: Aug. 30, 2012

(54) PIPELINE MONITORING SYSTEM

(76) Inventors: Songhao Wang, Pittsburgh, PA (US); Ronald Garcia, Jinotepe (NI); Pei-Hua Chang, Tainan (TW)

(21) Appl. No.: 13/036,552

(22) Filed: Feb. 28, 2011

(51) Int. Cl. G05B 23/02

(52) U.S. Cl. 340/3.1

(57) ABSTRACT

A pipeline monitoring system includes at least one power generating device and at least one information device. The at least one power generating device generates electric power by movement of the fluid in the pipeline so as to power the at least one information device which then sends a signal and the monitors judges the problem of the pipeline according the signal, such that the maintenance is timely provided.

### FIELD OF THE INVENTION

The present invention relates to a monitoring system, and more particularly, to a pipeline monitoring system which monitors the volume of the fluid passing through the pipeline and judges the position where the abnormal signal is generated.

### BACKGROUND OF THE INVENTION

A conventional pipeline for delivery of water, oil, gas or the like from one position to another is built on the ground or under the ground so as to reduce the cost of transportation. However such pipeline system is damaged due to the age, vibration such as earthquake, natural disasters or vandalism. The fluid leaks into the soil or rivers to cause significant contamination to the environment. The conventional way to find out the position where the leakage happens is to send observers to patrol along the pipeline and check the possible leakage by visual manner. This costs a lot of time and is inefficient if the pipeline is installed under the ground.

The present invention intends to provide a pipeline monitoring system which immediately finds out the exact damaged positions of the pipeline.

### SUMMARY OF THE INVENTION

The present invention relates to a pipeline monitoring system and comprises at least one power generating device and at least one information device, wherein the at least one power generating device comprises blades and at least one power generating unit is driven by the rotation of the blades so as to generate electric power. The at least one information device is driven by the electric power from the at least one power generating device and generates a signal. The position of the damage of the pipeline can be judged by the signal.

Preferably, the at least one information device is a wireless emitter and the signal is a first signal.

Preferably, a receiving member is installed to receive the first signal of the wireless emitter.

Preferably, the receiving member is connected to a vehicle on the ground or a flying object in the air.

Preferably, the flying object is a remote-control flying object and navigated by satellites.

Preferably, a receiving/emitting member is equipped to receive the first signal from the wireless emitter and the receiving/emitting member sends a second signal to a remote monitoring unit.

Preferably, the wireless emitter uses RFID or ZIGBEE technology and the first signal includes a code or a coordinate information which provides the receiving member to identify position of the first signal.

The system of the present invention is able to monitor the volume that pass through the pipeline and the power generating unit comprises two induction coil units which respectively provide electric power to the wireless emitter and a processor. The processor generates a data according to number of source of the electric power, and the data is sent to the wireless emitter and combined with the first signal.

The primary object of the present invention is to provide a pipeline monitoring system which is able to monitor the damaged position of the pipeline.

The response time can be reduced and the maintenance can be timely provided to reduce loss of cost.

The power generating device generates electric power to power the wireless emitter without equipped with extra power lines.

The maintenance cost can be reduced because of the rapid response and the volume of the fluid in the pipeline can be monitored.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pipeline monitoring system of the present invention;

FIG. 2 shows the pipeline monitoring system and the wireless emitter of the present invention;

FIG. 3 shows that the damaged position of the pipeline is judged according to the first signal;

FIG. 4 shows that the operator is acknowledged the damaged position of the pipeline by the received first signal;

FIG. 5 shows another embodiment of the pipeline monitoring system of the present invention, and

FIG. 6 shows that the power generating unit comprises two induction coil units and a processor.

### DETAILED DESCRIPTION OF THE PREFERRED EMBODIMENT

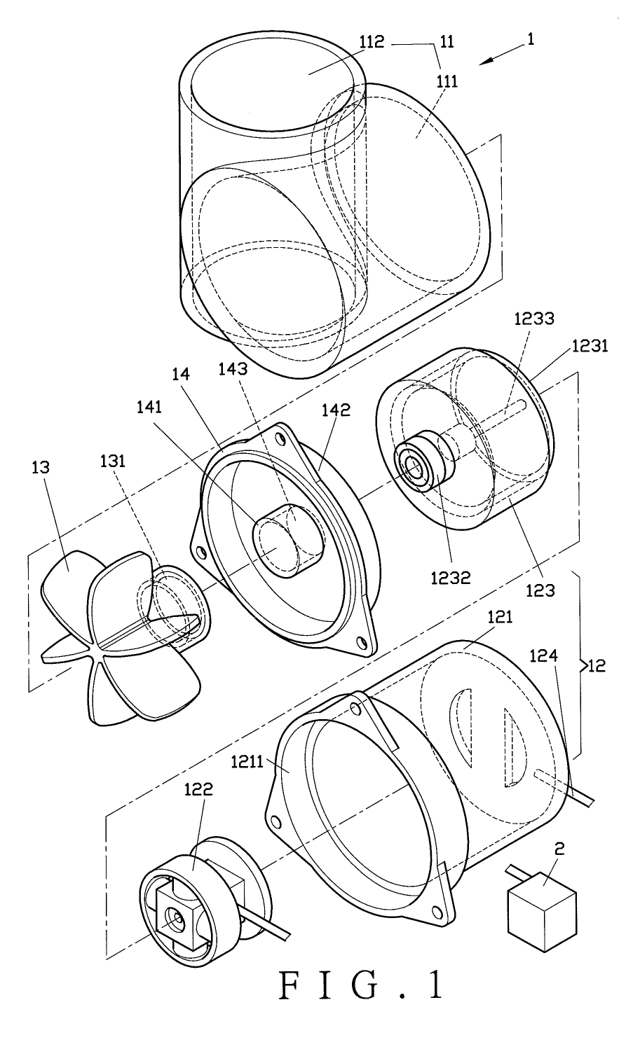

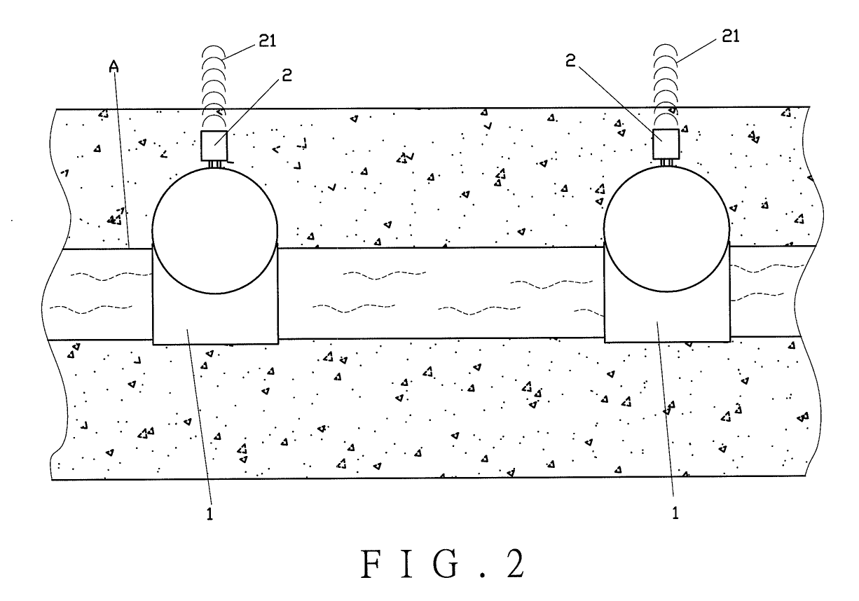

Referring to FIGS. 1 and 2, the pipeline monitoring system of the present invention is used for monitoring the long-distance pipeline “A” such as water pipes, oil pipes or gas pipes that are installed on the ground or under the ground. The pipeline monitoring system comprises at least one power generating device 1 which is installed to the pipeline “A” and generates electric power by movement of the fluid in the pipeline “A”. The at least one power generating device 1 comprises a case 11 and at least one power generating unit 12, wherein the case 11 has a room 111 which communicates with a pipe 112 at an angle. The pipe 112 communicates with the pipeline “A”. The room 111 has multiple blades 13 which are connected to a magnetic ring 131, and the blades 13 are located in the pipe 112. A cover 14 seals the room 111 and includes a hollow protrusion 141 and an engaging portion 142. The magnetic ring 131 is mounted to the hollow protrusion 141 and an opening 143 is defined in the opposite side of the cover 14. The blades 13 are located between the pipe 112 and the room 111, so that some blades 13 are driven by the flowing fluid and some of the blades 13 do not have any load applied thereto to reduce the resistance of the fluid. The rotation of the blades 13 is more sensitive. The power generating unit 12 is connected to the cover 14 of the case 11 and comprises a first housing 121 which has a recess 1211. The first housing 121 has an induction coil unit 122 connected to a center thereof and a second housing 123 is engaged with the recess 1211. A first magnet 1231 and a second magnet 1232 are located on the inner side and the outer side of the second housing 123. A shaft 1233 is located centrally in the second housing 123 and extends through the induction coil unit 122 corresponding thereto. The first magnet 1231 is located corresponding to the induction coil unit 122, and the second magnet 1232 is located corresponding to the opening 143 and is magnetically connected to the magnetic ring 131. The power generating unit 12 is connected to the cover 14 of the case 11 by engagement of the engaging portion 142 and the recess 1211. When the blades 13 rotate, the magnet ring 131 and the second magnet 1232 are rotated and the second housing 123 is rotated. The first magnet 1231 on the second housing 123 is rotated so that the induction coil unit 122 is rotated to generate electric power which is delivered by a cable 124 that is electrically connected to the induction coil unit 122.

At least one information device is electrically connected to the cable 124 so as to receive the electric power from any power generating device 1 and generates a signal. The at least one information device is a wireless emitter 2 which uses RFID or ZIGBEE technology. The at least one information device can also be other types of information device such as a light warning device. The signal is a first signal 21 and includes a code or a coordinate information (not shown). The first signal 21 can also be other types of signals such as light signals. The wireless emitter 2 provides the situation of the pipeline “A” and is not restricted in this invention.

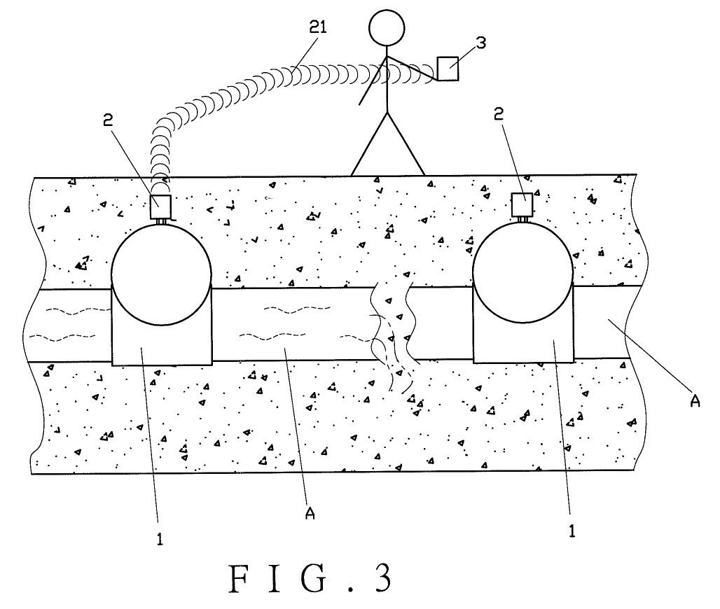

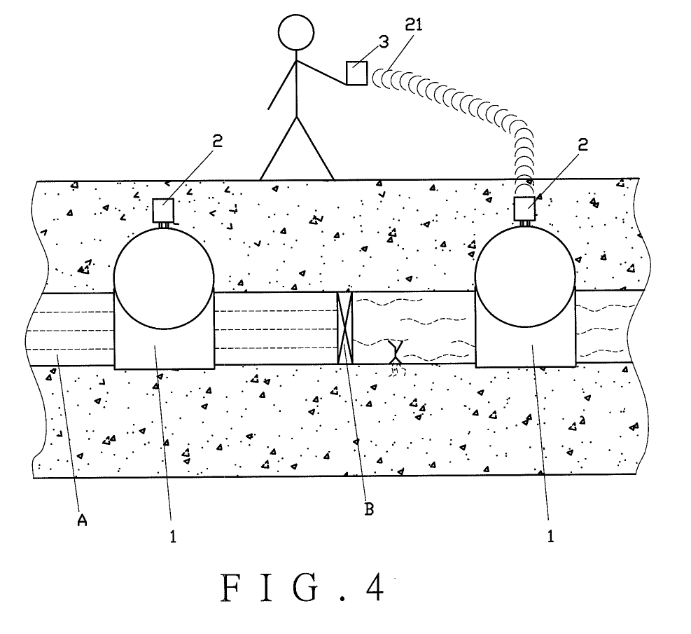

A receiving member 3 as shown in FIG. 3 receives the first signal 21 from the wireless emitter 2, and the first signal 21 includes a code or a coordinate information which provides the receiving member 3 to identify position of the first signal 21 so as to rapidly identify the position of the damaged position of the pipeline “A”. When the fluid in the pipeline A flow, the blades 13 will be rotated to drive the power generating unit 12 to generate electric power, which powers the wireless emitter 2 so that the wireless emitter 2 continuously sends the first signal 21 to be received by the receiving member 3. When the pipeline “A” is damaged, the fluid in the pipeline “A” cannot pass through so that the wireless emitter 2 cannot function due to lack of electric power. The receiving member 3 cannot receive the first signal 21 and the operator can identify the position where the first signal 21 fails to be sent. The position is the damaged position of the pipeline “A”. As shown in FIG. 4, the system can also be used to check cracks of the pipeline “A”. When the valve “B” of the pipeline “A” is shut off, if the receiving member 3 can receive the first signal 21, it means that the fluid is flowing in the pipeline “A”. The operator checks the position that receives the first signal 21 to judge the position of the leakage. The receiving member 3 is connected to a vehicle on the ground or a flying object in the air, wherein the flying object is a remote-control flying object navigated by satellites to shorten the time required for monitoring.

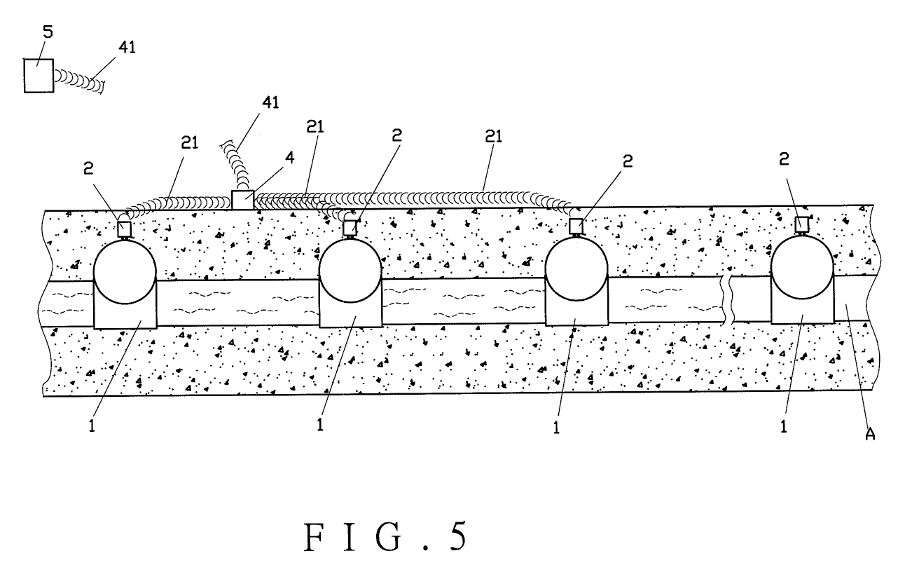

FIG. 5 shows another embodiment of the present invention wherein the receiving member 3 is replaced by the receiving/emitting member 4 which receives multiple first signals including code and coordinate information delivered by the wireless emitters 2. The wireless emitter 2 can only send signals to a short distance, and the receiving/emitting member 4 receives the first signals 21 and transfers these first signals 21 into second signals 41 and sends the second signals 41 to a remote monitoring unit 5 located at a long distance. Therefore, the remote monitoring unit 5 can monitor the condition of the pipeline “A”. Where the second signal 41 is not sent, the position is the damaged position.

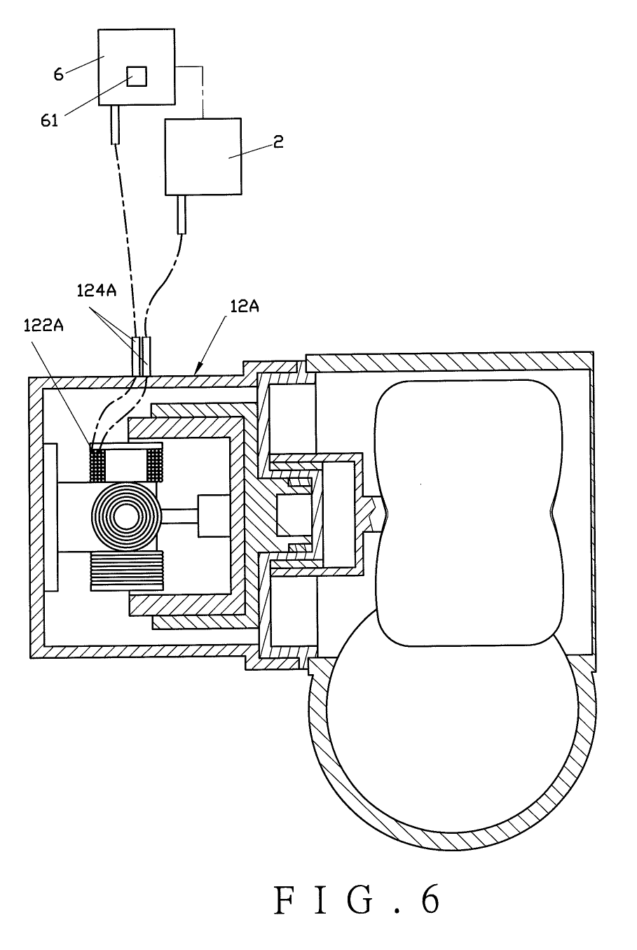

FIG. 6 shows yet another embodiment of the present invention. The power generating unit 12A comprises two induction coil units 122A which respectively provide electric power to the wireless emitter 2 and a processor 6 via two cables 124A. The processor 6 generates a data 61 according to number of source of the electric power, the diameter of the pipeline “A”, and the number of turns of the induction coil units 122A. The data 61 is the volume of the fluid passing through the pipeline “A”, and the data 61 is sent to the wireless emitter 2 and combined with the first signal 21. Therefore, the monitoring system can monitor the volume of the fluid in the pipeline “A” to judge the condition of the pipeline “A” by the first signals 21 received by the receiving member 3. The two respective sources of the electric power that provide the wireless emitter 2 and the processor 6 can avoid interference between the wireless emitter 2 and the processor 6 when they are powered by the same source of electric power. The interference makes the data 61 to be not precise and may affect the monitoring.

By the flowing fluid to drive the power generating device 1 to generate electric power, the electric power powers the wireless emitter 2 which generates the first signal continuously, so that the operator can judge the damaged position of the pipeline “A” according to the receiving of the first signal 21 and responds to the damage within a short period of time. Furthermore, the volume of the fluid can also be monitored. No extra electric power source is needed for the wireless emitter 2 and the processor 6 when the power generating device 1 is in function.

While we have shown and described the embodiment in accordance with the present invention, it should be clear to those skilled in the art that further embodiments may be made without departing from the scope of the present invention.

What is claimed is:

1. A pipeline monitoring system, comprising:
at least one power generating device having blades and at least one power generating unit driven by the blades so as to generate electric power, and
at least one information device driven by the electric power from the at least one power generating device and generating a signal.

2. The system as claimed in claim 1, wherein the at least one information device is a wireless emitter and the signal is a first signal.

3. The system as claimed in claim 2, further comprising a receiving member which receives the first signal of the wireless emitter.

4. The system as claimed in claim 3, wherein the receiving member is connected to a vehicle on the ground or a flying object in the air.

5. The system as claimed in claim 4, wherein the flying object is a remote-control flying object navigated by satellites.

6. The system as claimed in claim 3, wherein the wireless emitter uses RFID (radio frequency identification) or ZIGBEE technology and the first signal includes a code or a coordinate information which provides the receiving member to identify position of the first signal.

7. The system as claimed in claim 2, further comprising a receiving/emitting member to receive the first signal from the wireless emitter and send a second signal to a remote monitoring unit.

8. The system as claimed in claim 7, wherein the wireless emitter uses RFID or ZIGBEE technology and the first signal includes a code or a coordinate information which provides the receiving/emitting member to identify position of the first signal.

9. The system as claimed in claim 2, wherein the power generating unit comprises two induction coil units which respectively provide electric power to the wireless emitter and a processor, the processor generates a data according to number of source of the electric power, and the data is sent to the wireless emitter and combined with the first signal.
